(19) United States
(12) Patent Application Publication
(10) Pub. No.: US 2016/0267511 A1
(43) Pub. Date: Sep. 15, 2016

(54) SYSTEM AND METHOD FOR SPONSORSHIP MANAGEMENT

(71) Applicant: MXM Nation Inc., Toronto (CA)

(72) Inventors: Myles BARTHOLOMEW, Waterloo (CA); Gary BARTHOLOMEW, Mississauga (CA)

(73) Assignee: MXM Nation Inc., Toronto, ON (CA)

(21) Appl. No.: 15/023,347

(22) PCT Filed: Sep. 20, 2013
(86) PCT No.: PCT/CA2013/050723

§ 371 Date: Mar. 18, 2016

(51) Int. Cl. G06Q 30/02; G06Q 50/00

(52) U.S. Cl. CPC G06Q 30/0222; G06Q 50/01; G06Q 30/0231; G06Q 30/0214

(57) ABSTRACT

Described herein is a system for promoting a user of a social network from a first discount level to a second discount level for purchasing a sponsor's product, comprising: a storage system for storing user records and sponsor records, each user record comprising a user identifier and a quantity of credits allocated to the user and each sponsor record comprising a sponsor identifier, a quantity of sponsor-purchased credits, criteria for allocating credits and a credit threshold for promotion from the first discount level to the second discount level; and a processor for receiving information relating to allocated credits from each user record and promoting the user from a first discount level to a second discount level for purchasing a sponsor's products by comparing the information relating to allocated credits to the credit threshold for the promotion, the second discount level providing a greater discount than the first discount level.

### BACKGROUND OF THE INVENTION

1. Field of the Invention

The present invention relates to sponsors rewarding endorsements by users, and more particularly endorsements by users within a social network.

2. Description of the Related Art

Powered by such tools as email, weblogs, bulletin boards, chat rooms, streaming video, image uploads and instant messenger, computer-networked communication has given rise to different types of online communities or social networks. Online users form or join social networks for different reasons such as information exchange, friendship, social support, and recreation. The rapid growth of social networking platforms such as MySpace, Facebook, LinkedIn, Twitter is evidence of a multiplier effect of online computer-networked communication as online users share profiles, likes, dislikes, photos, videos, music, contacts and the like with friends and strangers.

General social networking platforms such as MySpace, Facebook, LinkedIn and Twitter are horizontal social networks as online users are not united by a specific subject matter, topic, interest or value. By comparison, vertical social networks are regarded as online social communities that are maintained by individuals to exchange a shared subject matter, topic, interest or value with current and potential community members in an ongoing manner. Vertical social networks can exist within horizontal social networks or can be formed independent of horizontal social networks. An example of a vertical social network within a horizontal social network is a celebrity such as Justin Beiber or Michael Jordan and their network (vertical) within the Facebook (horizontal) platform.

The potential for consumer-to-consumer marketing within the online communication of social networks has been recognized. Several systems for rewarding online referrals of goods or services have been proposed including those disclosed in U.S. Pat. No. 6,289,318 (issued 11 Sep. 2001), U.S. Pat. No. 7,568,004 (issued 28 Jul. 2009), U.S. Pat. No. 7,664,726 (issued 16 Feb. 2010), U.S. Pat. No. 8,306,874 (issued 6 Nov. 2012) and US Patent Publication Nos. 20080010139 (published 10 Jan. 2008), 2011/0208572 (published 25 Aug. 2011), 2011/0313832 (published 22 Dec. 2011), 2012/0278146 (1 Nov. 2012) and 2013/0166364 (27 Jun. 2013). However, no referral reward system has yet been widely adopted for computer network mediated marketing purposes. One problem may be that most referral reward systems do not provide an immediate benefit to the referrer. Another problem may be that most referral reward systems require that a connection of the referrer act on the referral in order to initiate a reward. Dependence on the actions of connections creates a tracking barrier and a disincentive for the referrer to engage in a referral process, as the referrer does not have the tools to track a connection's actions. Another problem may be that existing referral reward systems are typically practiced by individual companies allocating points under a single reward scheme and are not easily scaled up to include multiple companies allocating points under multiple reward schemes.

Accordingly, there is a continuing need for a system and method to reward endorsements in computer-mediated social networks.

### SUMMARY OF THE INVENTION

In an aspect there is provided a system for promoting a user of a social network from a first discount level to a second discount level for purchasing a sponsor's product, comprising: a storage system for storing a plurality of user records and a plurality of sponsor records, each user record comprising a user identifier and a quantity of credits allocated to the user and each sponsor record comprising a sponsor identifier, a quantity of sponsor-purchased credits, criteria for allocating credits and a credit threshold for promotion from the first discount level to the second discount level; and a processor for receiving information relating to allocated credits from each user record and promoting the user from a first discount level to a second discount level for purchasing a sponsor's products by comparing the information relating to allocated credits to the credit threshold for the promotion, the second discount level providing a greater discount than the first discount level.

In another aspect there is provided a method for promoting a user of a social network from a first discount level to a second discount level for purchasing a sponsor's product, comprising: storing user records in a storage system, each user record comprising a user identifier and a quantity of credits allocated to the user; storing sponsor records in the storage system, each sponsor record comprising a sponsor identifier, a quantity of sponsor-purchased credits, criteria for allocating credits and a credit threshold for promotion from the first discount level to the second discount level; receiving information relating to allocated credits in a user record; and promoting the user from a first discount level to a second discount level for purchasing a sponsor's products by comparing the information relating to allocated credits to the credit threshold for the promotion, the second discount level providing a greater discount than the first discount level.

In yet another aspect there is provided a system for allocating credits to a user of a social network for a user action that endorses a sponsor, comprising: a storage system for storing a plurality of user records and a plurality of sponsor records, each user record comprising a user identifier and credits allocated to the user and each sponsor record comprising a sponsor identifier, sponsor-purchased credits and criteria for allocating credits; and a processor for receiving information relating to a user action and allocating credits by comparing the information relating to the user action to the criteria for allocating credits set by the sponsor.

In still another aspect there is provided a method for allocating credits to a user of a social network for a user action that endorses a sponsor, comprising: storing user records, each user record comprising a user identifier and credits allocated to the user; storing sponsor records, each sponsor record comprising a sponsor identifier, sponsor-purchased credits and criteria for allocating credits; receiving information relating to a user action in a social network; allocating credits by comparing the information relating to the user action to the criteria for allocating credits set by the sponsor.

In a further aspect there is provided a system for tracking a transactional history of credits transferred from a first sponsor to a second sponsor, comprising: a storage system for storing a plurality of credit records and a plurality of sponsor records, each credit record comprising a credit identifier and a log of the transactional history of the credit and each sponsor record comprising a sponsor identifier, sponsor-purchased credits and criteria for allocating credits; and a processor for receiving information relating to the original purchaser of each credit and each subsequent transfer of the credit and registering the information in the log of the transactional history of the credit.

In a yet further aspect there is provided a method for tracking a transactional history of credits transferred from a first sponsor to a second sponsor, comprising: storing credit records, each credit record comprising a credit identifier and a log of the transactional history of the credit; storing sponsor records, each sponsor record comprising a sponsor identifier, sponsor-purchased credits and criteria for allocating credits; receiving information relating to the original purchaser of each credit and each subsequent transfer of the credit; and registering the information in the log of the transactional history of the credit.

In a still further aspect there is provided a system for allocating credits to a plurality of users on a social network for user actions that endorse a sponsor comprising: a sponsor manager module in communication with an administrator module from which the credits are purchased by the sponsor, the sponsor manager module having access to the social network, the social network notifying the sponsor manager module of the user actions and allocating credits to the plurality of users based on the user actions; and a storage system accessible by the administrator module for storing a plurality of user records and a plurality of sponsor records, each of the plurality of user records having a user identification and a balance of the credits allocated to the user, each of the plurality of sponsor records having a sponsor identification, an account of credits purchased by the sponsor, and the criteria for allocating the credits to the plurality of users based on the user actions set by the sponsor.

In an even further aspect there is provided a method of allocating credits to a user of a social network for a user action endorsing a sponsor, comprising: apportioning credits purchased by the sponsor from an administrator in a sponsor account; defining an array of a plurality of user actions and correlating a credits value for each of the plurality of user actions; allocating the credits value correlating to the user action defined by the array when the social network notifies the sponsor of the user action; and updating a user credit balance with the allocated credit value and updating the sponsor account with the transfer of allocated credits to the user.

### BRIEF DESCRIPTION OF THE DRAWINGS

FIG. 1 shows a block diagram describing a flow example of a user interaction with a sponsorship management system;

FIG. 2 shows a block diagram describing a flow example of a sponsor interaction with the sponsorship management system;

FIG. 3 shows a block diagram describing a flow example of a user action monitoring component of the sponsorship management system;

FIG. 4 shows a block diagram describing a flow example of a user interaction with the sponsorship management system to transition from a first discount level to a second discout level;

FIG. 5 shows a system map describing an illustrative implementation of the sponsorship management system in a geographically centralized computer system;

FIG. 6 shows a system map describing an illustrative implementation of the sponsorship management system in a geographically distributed computer system;

FIG. 7 shows a system map describing an alternative illustrative implementation of the sponsorship management system in a geographically distributed computer system;

FIG. 8 shows a block diagram describing an example of a credit converter component of the sponsorship management system;

FIG. 9 shows a block diagram describing a flow example of a sponsor allocating credits to a user;

FIG. 10 shows a block diagram describing a flow example of a user leveraging credit holdings to unlock a desired feature of the sponsorship management system;

FIG. 11 shows a block diagram describing a flow example of tracking a transfer of credits from sponsor to user;

FIG. 12 shows a block diagram describing a flow example of tracking a redemption of credits by a user;

FIG. 13 shows a block diagram describing a flow example of tracking a purchase of credits by a sponsor or user.

### DETAILED DESCRIPTION OF THE PREFERRED EMBODIMENT

A sponsorship management system, or method for providing the same, includes each of a plurality of sponsors purchasing credits from an administrator and allocating the purchased credits to users for actions that endorse a sponsor. Each credit may be associated with several identifiers including an identifying code and an identifier relating to the current owner of the credit. Typically, each transaction or transfer of each credit will be tracked and registered such that the transactional history of each credit may be documented.

A typical sponsor may be any legal entity having a vendible product (ie., a good and/or a service) and wishing to reward user actions that endorse or promote a sponsor's name, products, activities and the like by providing the user with credits that can be accumulated to yield a discount for purchasing the sponsor's product(s). Typically, a plurality of sponsors will participate in the sponsorship management system.

A typical user may be any individual or legal entity, including for example individual consumers, groups or associations of individuals, or businesses, that wish to purchase a product (ie., a good and/or a service) from one or more of a plurality of sponsors participating in the sponsorship management system.

The system may allow users an immediate benefit of membership in the system by providing upon enrollment a base discount level for purchasing one or more products of participating sponsor(s).

The system may allow for a transparent scheme for sponsors to reward promotional actions such as endorsements, testimonials, referrals and the like by establishing predetermined correlation of credits to promotional actions that do not require a contact of the user (eg. another user) to act on the promotional action.

The system may allow for scale-up to accommodate a plurality of sponsors by requiring sponsors to purchase a majority of the credits that are circulating in the system at any given time point. Requiring sponsors to purchase credits sets a standard for a plurality of sponsors to compete for the promoting actions of users and mitigates inflation that may occur if sponsors were permitted to arbitrarily generate credits.

Referring to the drawings, an example of the system, and method for providing the same, will be described in the context of a user and a sponsor interaction for illustrative purposes. In practice, the system and method can accommodate any number of user-sponsor interactions including one-to-one, one-to-many, many-to-one and many-to-many.

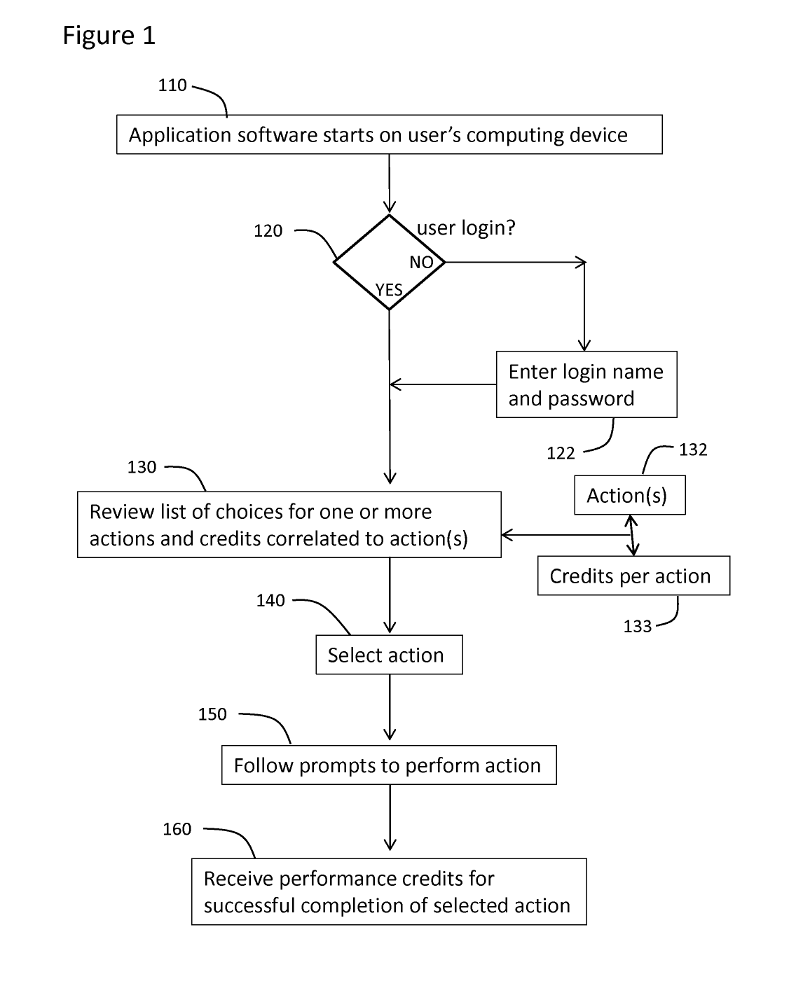

FIG. 1 shows a block diagram describing an example of a user performing a promotional action within the system. The user may perform the steps shown in FIG. 1 using an application installed on a personal computing device or using a website interface for an online application connected to a server computer. For convenience the steps are described in the context of an application installed on the user's personal computing device. Typically, upon start up of the user's computing device an end-user interface application software previously installed on the computing device will start (110) and initiate a networked communication with a server computer of the system. The server computer will typically require login information (120) that may be provided by the application software in the form of a stored electronic data packet such as an electronic cookie. In the absence of automated login information provided by the application software, the user is prompted to manually enter the login information (122) such as a login name and password. Once in a logged in environment the user can access a list (130), for example as a pull down menu, of promotional action types (132) and correlated credit values (133) predetermined by a sponsor. Alternatively, the system may generate and provide the user with one or more options to perform a promotional action (130) in a context dependent fashion, for example the system may provide a different set of options based on geographical location of a user's personal computing device within a retail outlet of a sponsor versus an Internet search for a sponsor's product. The system generated context dependent options will typically be a subset of a full list of promotional action types (132) and correlated credits (133) predetermined by the sponsor. Moreover, a sophisticated or experienced user may have a prior understanding of the credits scheme set by the sponsor and may not need or desire to access lists or be provided with system generated options to perform promotional actions. Regardless of whether the user understands the options for promotional actions through intentional navigation of the application interface, receiving a system generated list, or prior experience, the user selects a promotional action relevant to the sponsor (140). The system may generate prompts to guide the user to perform the selected action (150). However, sophisticated users may be able to perform the promotional action without using prompts from the application interface.

Promotional actions are any type of actions predetermined by the sponsor as being beneficial to the reputation of the sponsor and include, for example, a purchase, a scan of a product code, a geographical check-in, an image of a product posted on a website, a text testimonial posted on a website, a video testimonial posted on a website, or a video showing use of the product posted on a website. Various alternatives for performing an action may be accommodated by the application software. For example, if the action is to post an image of a sponsor's product on a website then the application software can provide a choice of selecting an image from a gallery of the sponsor's product images stored in memory, allowing the user to take a picture of the product with the user's computing device if it includes a digital camera, or uploading an image of the product captured by the user with a separate digital camera.

After the user completes the action the system validates the action as a promotional action and updates the user's credit balance to add the predetermined credits correlated to the promotional action (160) and also subtracts the credits from the sponsor's credit balance. Furthermore, the transactional history of each credit added to the user's credit balance is updated to register the transfer of the credit to the user (not shown).

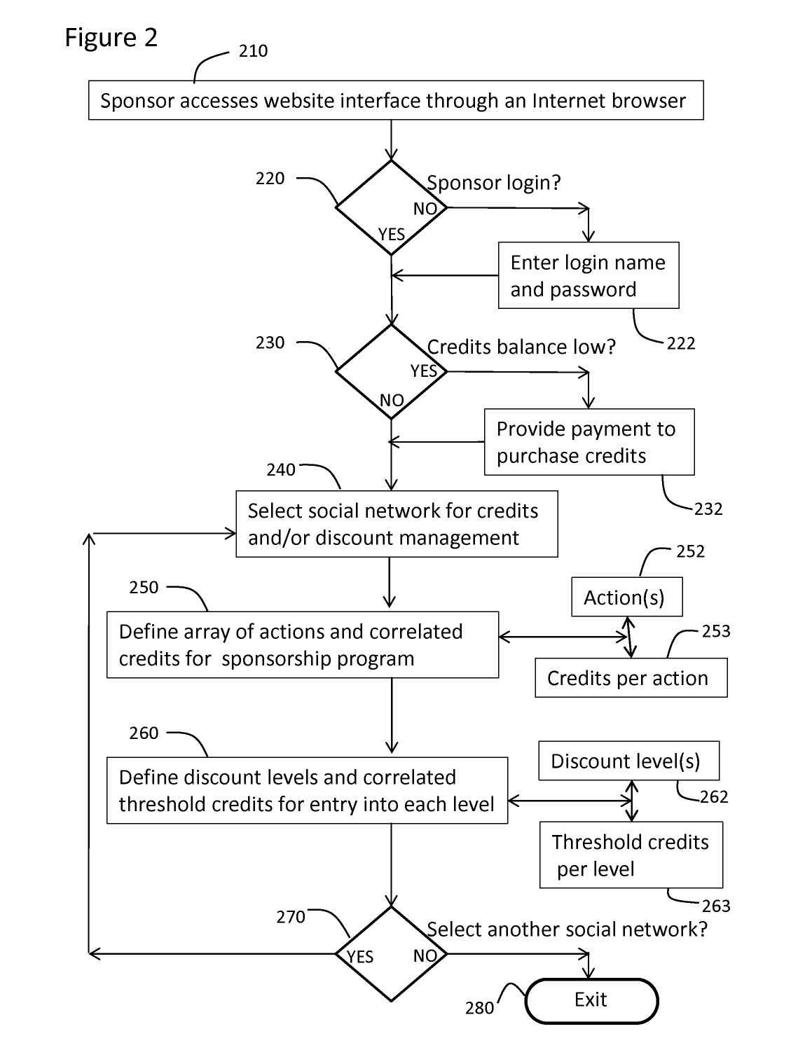

FIG. 2 shows a block diagram describing an example of a sponsor using the system to initially establish criteria for allocating credits to users that perform a promotional action and to establish credit thresholds for a plurality of discount levels for purchase of the sponsor's products. The sponsor may perform the steps shown in FIG. 2 using an application installed on a personal computing device or using a website interface for an online application hosted on a server computer. For convenience the steps are described in the context of the sponsor's interaction with a website interface. Typically, the sponsor uses an Internet browser on the sponsor's computer device to initiate a networked communication with a website interface (210) hosted by a server computer of the system. The server computer will typically require login information (220) that may be provided by the sponsor's computer device in the form of a stored electronic data packet such as an electronic cookie. In the absence of automated login information provided by the sponsor's computer device, the sponsor is prompted to manually enter the login information (222) such as a login name and password. Once in a logged in environment the sponsor may observe the credit balance held in the sponsor's account (230) and if the sponsor considers the credit balance to be low the sponsor may purchase credits (232) to ensure that the sponsor's account remains active. Alternatively, the sponsor's account may have an automatic top up of credits if it reaches a low credit balance limit that the sponsor can select and set. For example, if the sponsor's account credit balance falls below a 200 credit limit predetermined by the sponsor, then an automatic payment is made via a sponsor's stored payment method to top the sponsor's account up to 1000 credits (not shown). The sponsor can then select a social networking website (240) communicative with the system to establish criteria for allocating credits for promotional actions (250) performed by the users of the social networking website and to establish criteria for allowing the users access to a plurality of discount levels to purchase a sponsor's product (260).

To establish credit allocation criteria (250), the system may provide the sponsor with a datagrid check box allowing the sponsor to select promotional actions (252) from a list and to enter a credit value for each selected promotional action (253). Additionally, the sponsor may be permitted to enter a multiple value for each selected promotional action to define the number of times that each selected promotional action may be repeated before ceasing to earn credits according to the correlated credit value (not shown).

To establish criteria for access to discount levels (260), the system may provide the sponsor with a datagrid check box allowing the sponsor to select discount levels (262) from a list and to enter a credit threshold value for each selected discount level (263). Discount levels may be defined according to any conventional discounting scheme including percentage discounts or absolute value discounts on a minimum purchase. Typically, the system will allow the sponsor to select a base discount level that a user may access to purchase the sponsor's product regardless of the credit balance in the user's account. Further discount levels may be selected in a positively correlated tiered fashion with a discount level that provides a greater discount correlated with a greater credit threshold value. For example, a first discount level may be a base discount level correlated with a zero credit threshold value, and a second discount level correlated with a greater than zero credit threshold value will provide a greater discount than the first discount level.

Once the sponsor has established credit allocation and discount level criteria for a social networking website communicative with the system, the sponsor may apply the established criteria to any other social networking website communicative with the system or may execute steps 250 and 260 for each of the other social networking websites (270).). The sponsor may define different criteria for each social network as desired. The sponsor can create a template of criteria, copy it over to other networks and then modify the template to set criteria specific for each social network. This provides the sponsor with options to engage the user differently for each social network. Of course, if desired the sponsor may choose to engage them all with the same criteria. Thus, the sponsor is provided the option to tailor engagement strategies specifically for each social network and then for each discount level.

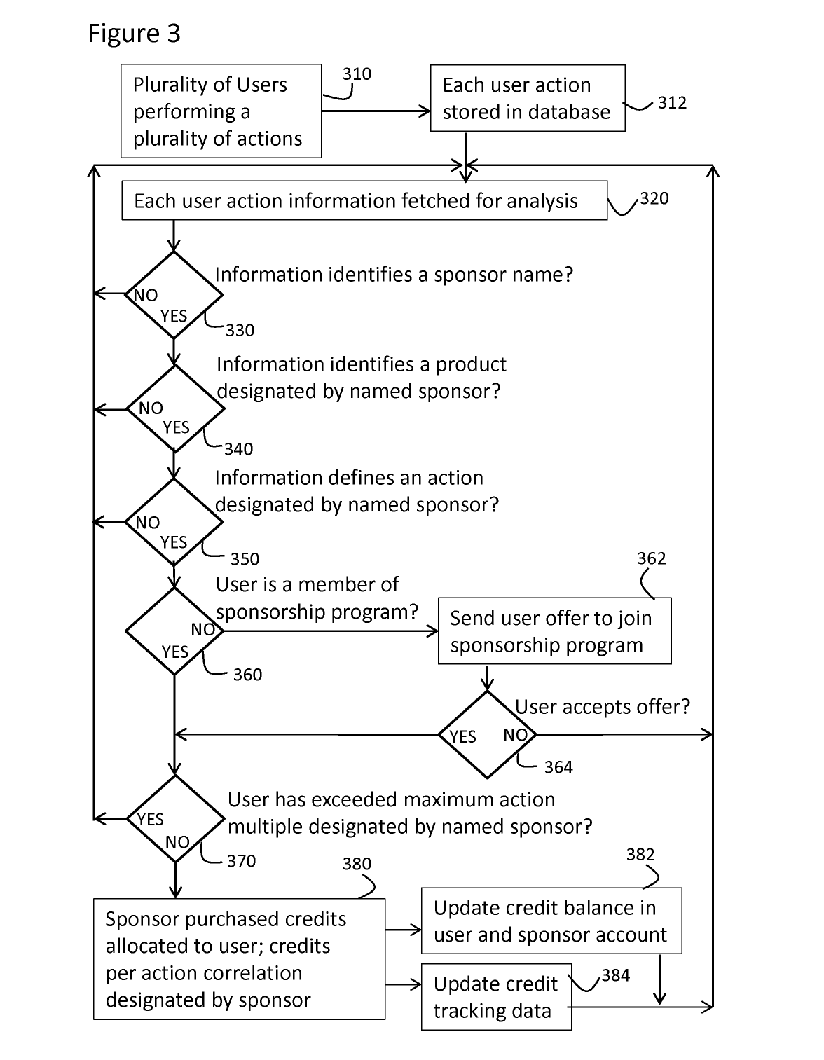

FIG. 3 shows a block diagram describing an example of a monitoring component of the system that monitors user actions and identifies promotional actions within a social networking website communicative with the system. In a social networking website there are many users, each performing a plurality of actions (310). The user actions are stored in a storage system controlled by the social networking website as well as being stored in a mirror storage system that can be accessed by the monitoring component (312). Data transfer to the mirrored storage system may be through a push or pull mechanism depending on the desired implementation. Out of the plurality of user actions, a portion will be promotional actions. Thus, to identify promotional actions each user action may be fetched from the mirror storage system (320) and analyzed or queried for the presence of aspects of a promotional action. A first query may be to assess that the information in the user action contains an identifier relating to a sponsor name or the sponsor name per se (330). A second query may be to assess that the information in the user action contains an identifier relating to a product of the named sponsor name or the name of the product per se (340). Alternatively, the first and/or second queries may be satisfied if a user posts an item directly on the sponsor's web page within a social networking web site. Accordingly, a user may receive credits for naming and mentioning the sponsor and/or the product without explicitly stating the sponsor's name or product. A user may receive full naming credits because the action was done within the sponsor's page. The system timeline can register that the user performed an action in the sponsor's page and the system will automatically provide links around that action, mentioning the sponsor's name/page. A third query may be to assess that the information in the user action defines an action with a corresponding credit value designated by the named sponsor (350), for example posting an image of a sponsor's product may correspond to 10 credits. In the example described in FIG. 3, if one or more of the first, second and third queries yields a negative response, then the action is not considered a promotional action and analysis proceeds to the next user action fetched from the mirror storage system. If all three queries are present then the action is considered to be a promotional action and the user is identified (360). If the user is a member of the sponsorship program then the user account is checked for credits received for previous actions having the same three characteristic features, and if the number of such previous actions equals or exceeds an action multiple value predetermined by the sponsor then the user is not provided with further credits and analysis proceeds to the next user action fetched from the mirror storage system. Otherwise, the system validates the action as a promotional action and credits purchased by the named sponsor are transferred to the user (380) by updating the user's credit balance to add the predetermined credits corresponding to the promotional action (382) and also subtract the credits from the sponsor's credit balance. Furthermore, the transactional history of each credit added to the user's credit balance is updated to register the transfer of the credit to the user (384). If the user is not a member of the sponsorship program then the user is presented with an offer to join (362) and upon acceptance of the offer, credits purchased by the named sponsor are transferred to the user according to steps 380, 382, and 384.

If the user exceeds the limit of credit issuance by allowed promotion action then the system will inform them of such and suggest other actions that are suggested to earn credits within the current sponsorship level of the sponsor. This allows the user to engage further on other activities that the sponsor deems valuable as promotion of the sponsor. Gamification of the credit issuance such as how many more credits does a user need to gain access to the next discount level, or how many days based on the user activity history can be used to encourage user engagement in a sponsor directed fashion.

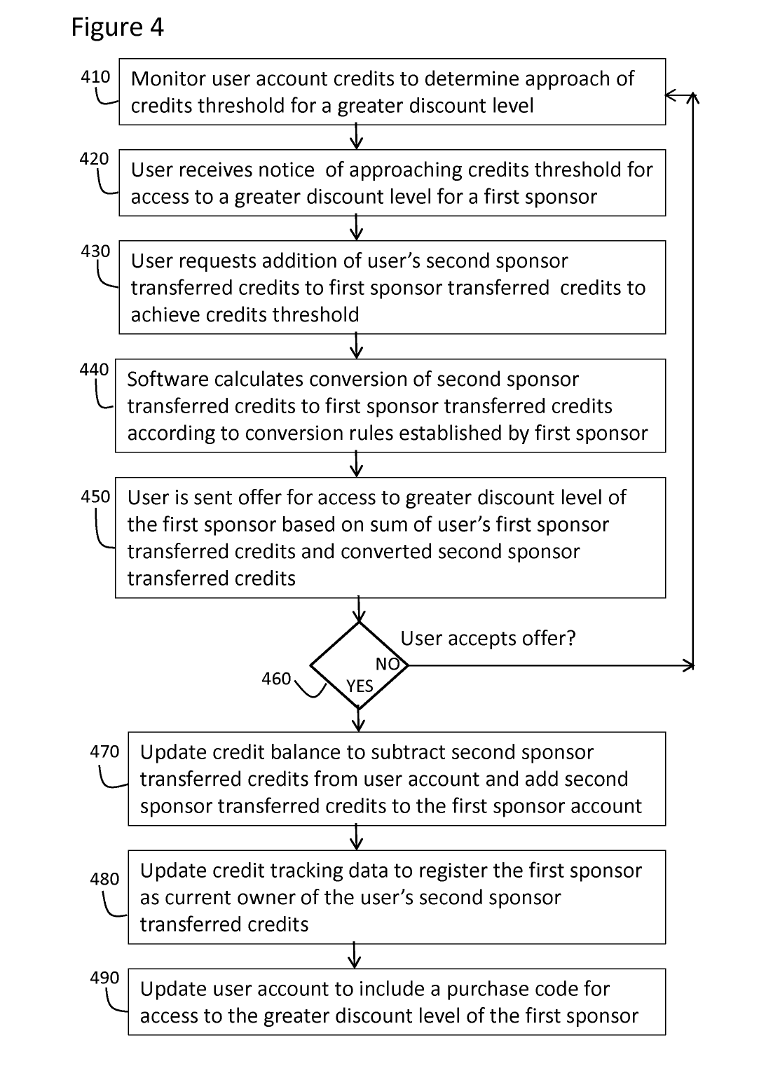

FIG. 4 shows a block diagram describing an example of the system promoting a user from a first discount level of a sponsor to a second discount level of the sponsor, the second discount level providing a greater discount than the first discount level. Since the system will typically comprise a plurality of participating sponsors, a user account may hold sponsor allocated credits from a plurality of participating sponsors. While FIG. 4 describes an example of a user account holding credits allocated from first and second sponsors, it will be recognized that the system can accommodate credits allocated from a greater number of sponsors. The user accounts are monitored to determine credit totals on a sponsor specific basis (410). In this example, the first sponsor allocated credit total is greater than the second sponsor allocated credit total and is closer to the credit threshold established by the first sponsor. The system notifies the user (420) when the user account holdings of the first sponsor allocated credit total approaches a predetermined credit threshold established by the first sponsor for promoting a user from the first discount level to the second discount level. This notification can serve to motivate the user to perform promotional activities relating to the first sponsor to earn credits to achieve the credit threshold. In the absence of earning further credits, the user may be provided an opportunity to purchase credits (not shown). Alternatively, in the absence of earning further first sponsor allocated credits, the notification can allow the user to request conversion of all or part of the user account holdings of the second sponsor allocated credits to make up the difference between the current holdings of the first sponsor allocated credits and the credit threshold (430). The system calculates conversion of the second sponsor allocated credits to first sponsor allocated credits according to predetermined conversion rates established by the first sponsor or an administrator of the system (440). If the sum of the first sponsor allocated credits and the converted second sponsor allocated credits is sufficient to equal the credit threshold then the user is offered access to the second discount level (450). If the user accepts the offer (460) then credit balances of the user's account and the first sponsor's account are updated to reflect transfer of the second sponsor allocated credits from the user's account to the first sponsor's account (470) and to update the transactional history of each credit transferred to the first sponsors account to register the first sponsor as current owner of each of these credits (480). Furthermore, the user's account is updated to include a purchase code that may be graphically represented as a discount coupon or badge for access to the second discount level of the first sponsor and the user retains holdings of the first sponsor allocated credits. It will be recognized that rules for conversion and transfer of credits may vary widely depending upon a desired implementation. For example, a transfer of both first sponsor allocated credits and second sponsor allocated credits may occur in exchange for a discount coupon or badge such that the user holdings would be depleted of the first sponsor allocated credits. In a further example, the transfer of first and second sponsor allocated credits may be transferred to an administrator of the system instead of the first sponsor's account. In still a further example, when a user is promoted to a next sponsorship level a fee may be assessed by the administrator in the form of credits, representing 1-5% of the total credits required to gain access to the next level. These credits can be returned to the administrator's treasury, with the original identifier still retained along with all the transactional history of usage and issuances on such credits. These credits can further be issued to sponsors by selling them to sponsors; consistently charging for credits controls deflation of value of the credits.

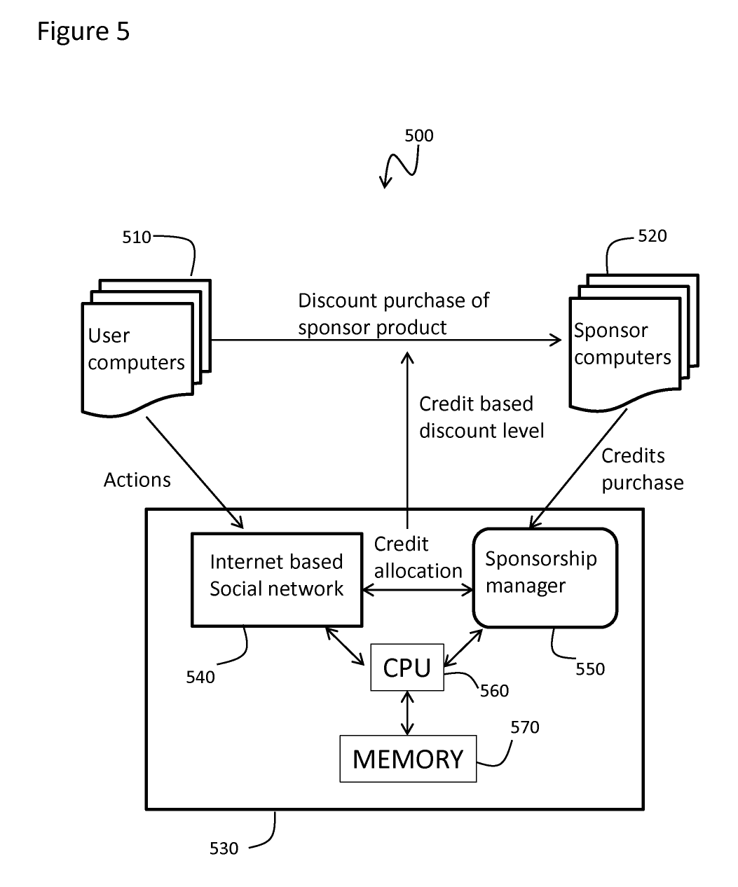

FIG. 5 shows a system map describing an example of an implementation (500) of the system. In the implementation (500) the system comprises a plurality of users (510) each with at least one computing device and plurality of sponsors (520) each with at least one computing device. User computing devices (510) communicate over a network with an interface of a social networking website (540) while sponsor computing devices (520) communicate with an interface for a sponsor manager website (550). The sponsor manager (550) is embedded in the social networking website (540) and hosted on a single server (530) with a processor (560) and a memory (570) operably linked to the social networking website interface (540) and the sponsor manager interface (550). Sponsor computing devices (520) may also include point of sale devices. Memory (570) may include volatile memory such as various RAM types, and non-volatile such as ROM, magnetic storage systems, optical storage systems and the like.

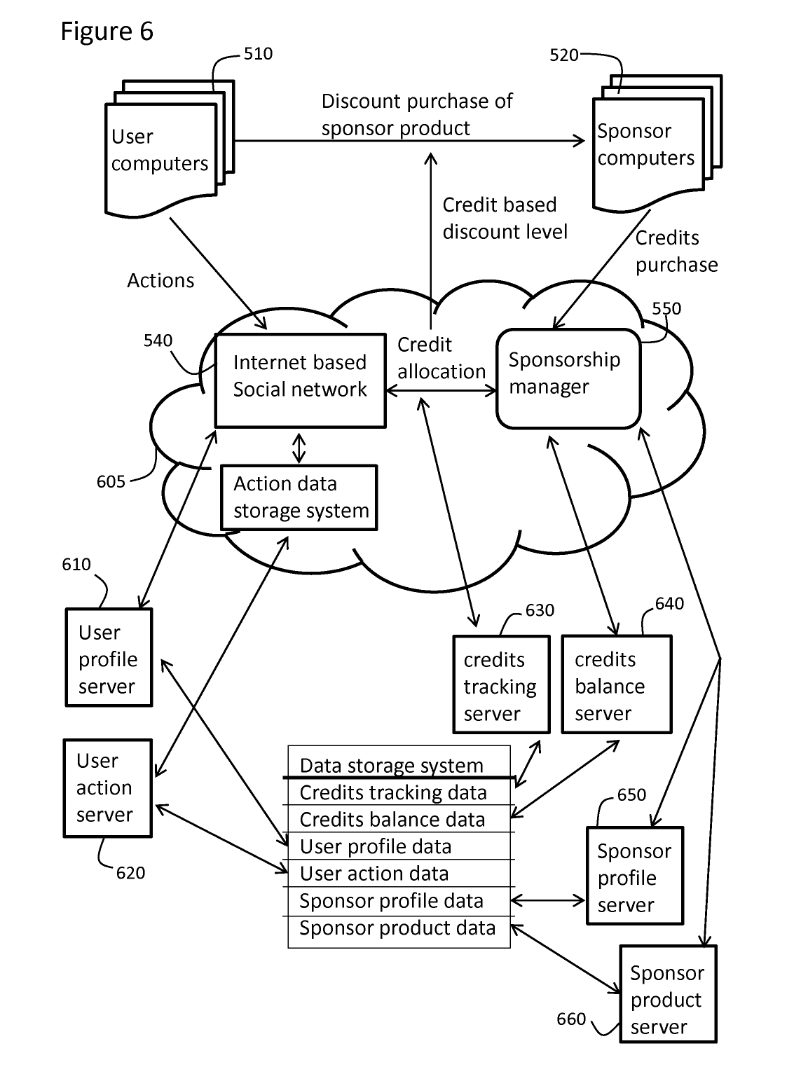

FIG. 6 shows a system map describing an example of a cloud (605) based implementation of the system where functions for maintaining and updating user profiles (610), monitoring and analyzing user actions (620), tracking and updating transactional history of each credit (630), updating and monitoring user and sponsor credit balances (640), maintaining and updating sponsor profiles (650), and maintaining and updating sponsor product information and e-commerce platforms (660) are distributed over a plurality of server computers and data storage systems.

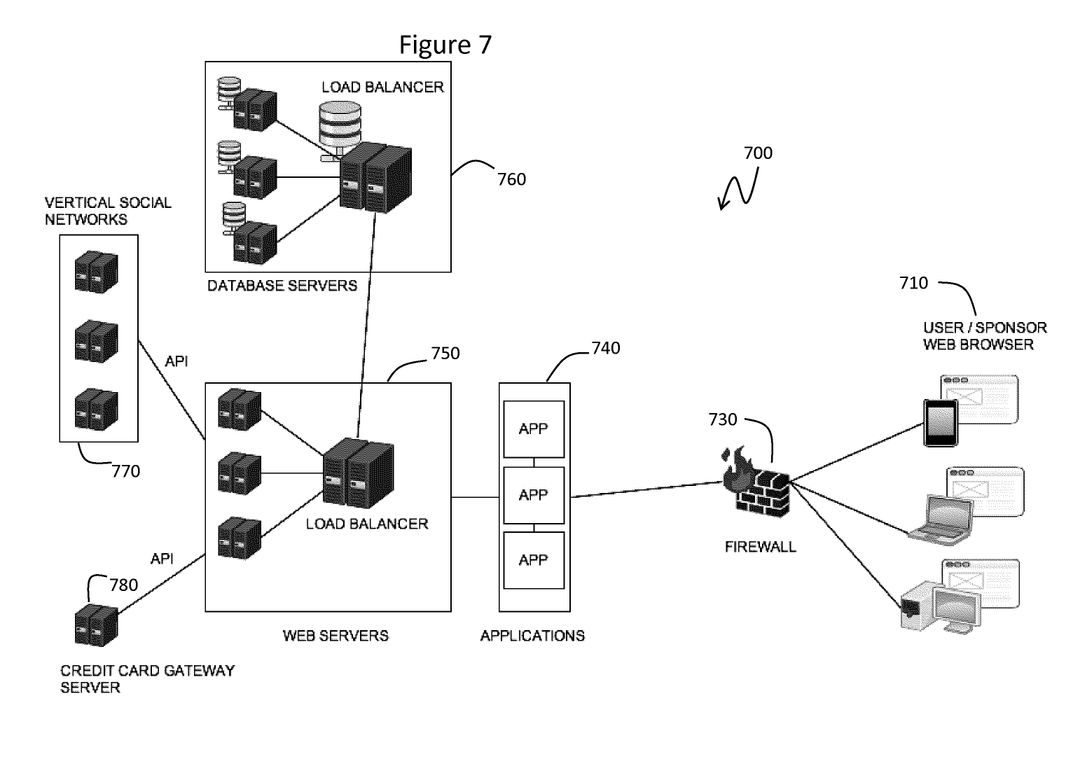

FIG. 7 shows a system map describing another example of an implementation (700) of the system. A plurality of user computing devices and a plurality of sponsor computing devices (710) communicate through a networked server firewall (730) with sponsor manager website applications hosted on load balanced web server farm (750) that is communicative with a load balanced database server farm (760) and application interfaces of a plurality of vertical social networks (770) and a credit card transaction processor (780).

In use, the sponsorship management system allows sponsors to effectively engage in many one-to-one relationships with users of a social networking web sites in that each user's promotional activity can be independently analyzed and compensated with performance credits based on a predetermined and optionally transparent credits per action correlation established by each sponsor.

The system may provide an immediate benefit to users by encouraging sponsors to provide a base discount level for purchase of a sponsor's product regardless of the credit balance in a user's account. The system can provide user interface elements to prompt and guide users to conveniently perform promotional actions to gain credits to achieve predetermined credit thresholds for gaining access to greater discount levels.

The system may provide a user the opportunity to donate, gift or transfer their earned credits to other users in such a way that the user can obtain higher sponsorship levels among sponsors that wish to reward the gifting or donating activity.

The system can allow a user to put credits up for auction, showing the due diligence on how the credit was originated giving higher value by association with higher value sponsors and allowing for less credits to be used due to their higher value to obtain a sponsorship level.

The system may provide for credits to be tracked in a database and analyzed for quality to determine valuation or conversion for trade among users and sponsors.

The system provides for analysis of credits, allowing association of influencers and premium brands, and allowing other brands to market through brand affiliation and premium user access and engagement.

The system can plug into any social or vertical network, offer an immediate engagement through sponsorship with a base discount, and monitor each users social media generated content to score such content for alignment with the sponsor's required promotional program, issuing and rewarding the user with credits.

The system can be readily scaled-up to accommodate a plurality of sponsors due in part to each sponsor having to purchase performance credits. Payment for performance credits allows credits to be standardized, allows a reference for the credit value during conversions of one sponsor's credits to another, and prevents sponsors from arbitrarily generating credits.

While the system may benefit all user's particularly in implementations where a base discount level is provided by the sponsors, the system will identify and reward online influencers that perform online promotional actions relating to one or more sponsors. Each user may be provided with a swipe card that encodes the base discount level and then may be provided with further discount coupons or discount badges as performance credits are accumulated to achieve predetermined credit thresholds for access to greater discount levels. The card may be virtual in the form of a mobile application for example, whereby the user checks in to a sponsor location and the discount code is automatically downloaded to the mobile device and scanned at the point of sale to apply the discount on purchases. The discount scan code can be provided by the sponsor by uploading a specific discount code associated with each discount level, with the appropriate code downloaded at check in to the user mobile device at the sponsor's location. The sponsor may bundle promotions with the discount code that in addition to the discount level the user is at may be added to the discount as a one time, daily, weekly, monthly or annual incentive on specific products and services. The sponsor can maintain this additional promotion on the system by setting criteria such as duration of the offer, specific product and service offering, discount and incentive etc. These promotions can be added at any time by the sponsor and added to any discount level differently.

Based on comparisons and analysis of the users promotional action history and performance credits transaction history, the system may be able to identify opinion leaders and opinion seekers. Opinion leadership is the process by which people (the opinion leaders) influence the attitudes or behaviors of others (the opinion seekers). Both opinion leaders and opinion seekers are significant for promotion of a sponsors brand name and products. The Internet not only provides opinion leaders with efficient ways to disseminate information, but also greatly facilitates information searching for opinion seekers.

Opinion leaders are defined as individuals who transmit information about a topic or product to other people, in terms of the extent to which information is sought by those people. Many opinion leaders may also be opinion seekers because they desire more knowledge or expertise, partly due to their interest in a specific topic or product. Opinion seekers look for information or advice from others when making an informed decision or taking action. When they perceive a risk in a certain situation, when they are not familiar with a topic or product, or when they find others' experience to be useful, they may actively seek out information or advice to inform their decision. Opinion seeking is a significant component of promotional communication because it facilitates information diffusion in the interpersonal communication process. Opinion leaders cannot exist without opinion seekers, and vice versa. Accordingly, the system, and method for providing the same, may reward both opinion leaders (for example, for posting a testimonial) and opinion seekers (for example, for interactions with the testimonial such as searching, reading, commenting, clicking and the like).

The system may be used in combination with an existing computer-mediated social network where users within a community come together for a common cause, topic or subject matter, such as friends like Facebook, profession like doctors or contractors, social causes like giving, health, community, etc. Alternatively, the system may be used to build such computer-mediated social networks.

The system can provide users of the social network an opportunity to connect with and engage one or more sponsors such as major brands, regional brands and vertical or specialized brands together. The sponsor offers an immediate benefit through this connection to the user with a base discount on all or certain products, ie. goods and/or services offered by the sponsor. The user engages with the sponsor one to one by using this base discount and can choose to further engage with the sponsor by performing promotional actions that benefit the reputation of the sponsor within this social network to be provided with performance credits. The user can choose to engage as much or as little as they wish.

The system may provide prompts in a convenient context dependent manner to encourage the user to perform a promotional action within the social network such as comments, check in to the brands store (physical or virtual), tweeting, posting commentary on goods, services, location, scanning product pictures, posting pictures and videos. The system may also provide complementary or gift credits to the user to encourage participation. The social network may also contribute performance credits to the user for activities that are not sponsor or brand specific, like filling out their complete profile, logging in, amount of engagement time on the system, interacting with other users.

The sponsor purchases credits from the system in order to give them away to the user for promoting the sponsor. As more credits are rewarded and accumulated specific to the sponsor the user may accumulate sufficient holdings of the sponsor specific credits to reach a credit threshold to gain access to a greater discount level to purchase the sponsor's product(s). The sponsor may define the number of discount levels that are available to be unlocked and accessed by the user with sufficient accumulation of credits, what discount will be offered at each level, the credit threshold to gain access to each discount level, and the strategy for earning credits within each level or tier.

As a user gains access to a greater discount level, the sponsor can provide to the user a discount code associated with the greater discount level and compatible with the sponsor's discount scan code used at point of sale devices. Each download and usage of the discount code can get logged and potentially constitute a user action to earn further credits. This discount code can be retrieved or automatically downloaded to a smart phone app and used when a user checks out with their purchase at the sponsor's point of sale location

The sponsor can set credit allocation criteria by specifying how many credits are to be transferred for each action and specifying by how many repetitions by a user are allowed for each specific action. For example, for a particular discount level if the sponsor specifies a multiple or repetition of three for an action mentioning a sponsor's brand name, then a user mentioning the brand name for a fourth in that discount level would not be awarded credits for the naming action.

The system can monitor user actions and the credits earned and held in user accounts and can encourage or prompt the user to deploy different strategies to earn more credits. For example, game dynamics can be deployed to show how many credits are held by the user in total and for each sponsor, what the user needs to do to earn more credits, how the user ranks relative to peers within the social network. Any ranking method may be used, for example a ranking based on engagement indexes and scores, on rate of credits being earned (who earned them the fastest), who has the highest engagement with specific sponsors.

The tiered discount levels may be graphically represented by badges. Badges may be purchased and issued by the sponsor to the user to allow access to an associated discount level. The badges can appear in the user profile web page identifying the sponsor that issued the badge. A fee for issuing the badge may be justified as the greater the discount level the obtained by the user, indicates a greater influence of the user within the social network and the more valuable the user is to the sponsor and the sponsor's brand, and the greater the cost to the sponsor to engage this user. Thus badges, like performance credits are purchased and allocated to the user based on predetermined and optionally transparent criteria set by the sponsor. The higher the discount level the user attains the more expensive the corresponding badge, providing a mechanism and reference to set the price on the influencers within the network.

If the sponsor issues performance credits to the user (sponsor allocated credits) and the system issues credits to the user (system credits) and the sponsor subsequently leaves the social network, the user can redeem these credits with appropriate credit conversions to achieve credit threshold to gain access to a discount level provided by another sponsor, thus creating a market for credits, and providing an ability for competing and/or complementing sponsors to acquire influencers. For example, a sponsor may be able to identify influencers within the social network based on user rankings and offer an incentive to the influencer by reducing the credit threshold or provide attractive conversion rates for entry into the sponsor's higher discount level tiers. As a more specific example, if the sponsor's top tier requires 10,000 credit to be earned in order to gain access by the user, and the sponsor identifies an influencer within the social network, the sponsor can discount the entry level from 10,000 to 5,000 incenting the influencer to join and engage. Then the rules of engagement within that tier are specified by the sponsor for this newly engaged influencer to earn credits.

As the user accumulates sponsor specific and system credit holdings, the user may choose to use the credit holdings to gain access to discount levels of other sponsor's that may not be prominent in the user's credit profile but that the user wishes to engage. Rules may be set to guide the conversion of a user's sponsor specific credits to other sponsor that are not competing but are complementary in deference to the civility and cooperative objectives of most social networks. For example, the user can offer credits to sponsors in an open notice and have the sponsors bid for the user, stating the discount level the sponsor is prepared to offer the user and for how many credits. When a user offers credits in a bid market, due diligence can occur by interested sponsors to determine how these credits were earned, for example the value of the credits may be positively correlated to the value of the sponsor that allocated them, such that credits may be deemed to be of a higher value if the credits were allocated by a premium brand. Thus, a sponsor considering bidding for credits in a bid market may discount or raise the value of credits depending on how they were originated and their transactional history. This allows the sponsor to align to desired brand influencers within the social network. If the credits were shown as purchased from the system and were not earned then they hold a lower value. If they are combined with credits that were earned and allocated through high quality promotional engagement from a high quality brand then the percentage of credits as the total offering can be analyzed. The sponsor may choose not to penalize the user for buying credits and combining them with high quality sponsor/activity allocated credits.

The system provides a marketplace for influencers to offer their promoting services to sponsors. Sponsors may compete for influencers of all levels offering influencers reductions from the sponsor's credit threshold requirements.

Users can transfer credits to their friends (other users) to help them out as socially responsible and gifting within the network. For example, credits may be gifted for free, credits may be loaned with a time period, or credits may be loaned with an interest rate (credits loaned for 1 year plus 50 credits). Users may be incented to gift and system credits can be transferred to the user that creates the gift as a way to encourage social responsibilities. Social initiatives can be launched within the social network in which user can donate credits to a cause. The cause (a user) can then use the donated credits to gain access to discount levels with sponsors and use this discount to reduce the costs of the cause.

Users can inspect and analyze their credits activity in a history log, for example credits used, earned, bought, transferred and what action created the credit allocation such as a post, a mention and with which sponsor. The user can see their sponsor engagement score, how they rank among other users with a certain brand, all within for example, a user account dash board format.

When a user applies to gain access to a sponsorship level of a sponsor, the sponsor can perform due diligence on the user analyzing how the user obtained their credits to earn influencer status, which brands they engaged with, how long it took to earn these credits, social contribution score, etc., and decide if they accept the influencer into their sponsorship level. The sponsor can define automatic acceptance criteria such as brands, and brand cluster the influencer has engaged with, or rate of accumulation and type of user engagement as an overall percentage of total engagement. The sponsor can define the logic for automatic acceptance and which applications for sponsorship get manually reviewed.

The system may include an application software installed on a user's mobile computing device that keeps the user connected to the system whenever the device is turned on. Using check-in geolocation technology the mobile application software can determine which sponsor's location has been entered and automatically download the correct discount scan code based on the discount level the user is currently at. The mobile application can allow the system to provide the user with context relevant prompts, such as prompts to the user detailing a number of purchases or actions specific to the sponsor, and perhaps even specific to the sponsor location, in order to earn sponsor specific credits or to move to a greater discount level. The system may also communicate and offer a sponsor's daily specials to the user that checked-in to the sponsor's location.

Sponsor purchases of credits cooperate with tiered discount levels and/or array of plurality of actions and credits per action to promote user and sponsor engagement with each other and with the system. Having sponsors pay to purchase credits and then further providing users with a discount may seem to be counterintuitive as both aspects appear to favor the user. However, the sponsor's motivation is that the two aspects cooperate to generate user engagement and purchases of the sponsor's products. The purchase of credits by the sponsor is useful to allow a level and controlled playing field for a plurality of sponsors. The purchase of credits provides an inherent reference and oversight mechanism for credit circulation. The input cost of the sponsors to purchase credits can be balanced by a benefit back to sponsors. The tiered discount levels and/or the credits per action array provide a user engagement greater than conventional reward point schemes of providing a user points and having them redeem points, because with the sponsorship management system described herein the user is continuously provided with greater opportunity if they remain engaged with the sponsor brand and products. Bundling further promotions with discount levels, such as adding a specific daily special above and beyond the discount level, encourages further engagement. For example, if the user is at a sponsor's top level, the sponsor (eg. Avis Rent a Car) may decide that all top tier users will get 2 days free on top of the top level discount and the top tier users promote the additional 2 days free once they take it, motivating other users by promoting the benefits of top level engagement. In the sponsor's interest, the additional promotions, such as 2 days free from Avis Rent a Car, can be used to help clear out inventory or sell off capacity and offers the sponsor inventory management and controls to move goods and services that may be lagging in inventory.

An example of the system and several illustrative variants have been described above. Further illustrative variants and modifications will now be described. Still further variants, modifications or combinations thereof will be recognized by the person of skill in the art.

The system may accommodate a great degree of variability or diversity with respect to criteria for allocating, transferring, converting, and/or tracking credits. Furthermore, mechanisms for setting the criteria may vary according to a desired implementation. Still further, the criteria may relate to each credit or an increment or packet of credits depending upon a desired implementation. However, throughout various implementations of the system a constant feature will be that sponsors will purchase credits. The entirety of credits held in a sponsor's account need not have been purchased. For example, a newly enrolled sponsor or user may receive gifted credits as part of a welcome package. The system may gift credits to a sponsor or user for any suitable reason such as recognition of longevity, outstanding social activity, or in a more general example, as an incentive to enhance participation in the system. Furthermore, users may be given opportunities to purchase credits. Thus, the entirety of the credits circulating in the system need not be sponsor purchased credits. The proportion of total circulating credits that relate to sponsor purchased credits may be quantified by at least calculations. First, typically at least 30% of credits circulating in the system at any given time will be the cumulative sum of currently owned sponsor purchased credits and credits previously purchased by sponsors. For example, at any given time the cumulative sum of currently owned sponsor purchased credits and credits previously purchased by sponsors may be greater than 40%, 50%, 60%, 70%, 80%, 90% of the total credits circulating in the system. A second quantification of the proportion of total circulating credits that relate to sponsor purchased credits can be determined by identifying the percentage of total credits circulating in the system that originated as sponsor purchased credits. A credit is considered to have been originated as a sponsor purchased credit if the initial transfer of a credit within the system is in exchange for payment provided by a sponsor. Typically, at least 30% of credits circulating in the system at a given time will have originated as sponsor purchased credits. For example, at any given time the aggregate of credits originated as sponsor purchased credits may be greater than 40%, 50%, 60%, 70%, 80%, 90% of the total credits circulating in the system. In both quantifications, a level of greater than 50% will generally be associated with efficient functioning of the system.

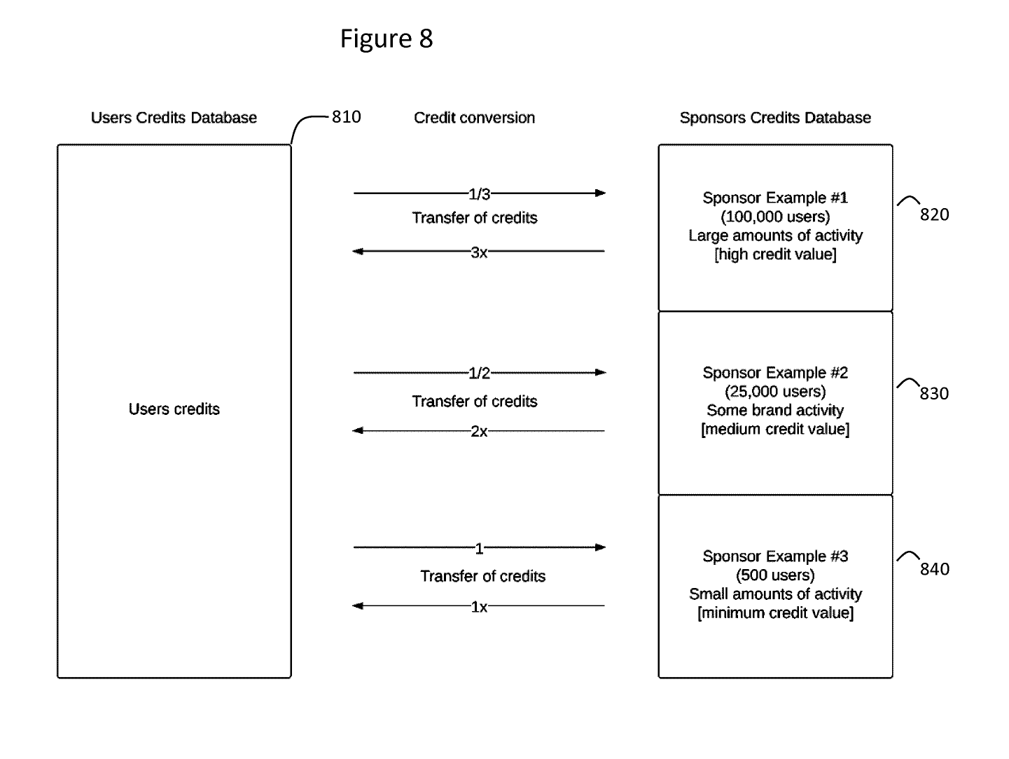

Many different conversion schemes to convert a first sponsor's credits to a second sponsor's credits may be accommodated by the system. For example, the second sponsor may provide an offer of conversion to a first sponsor or a user holding first sponsor allocated credits with the offer being accepted or rejected at the discretion of the first sponsor or user, respectively. Another example of a conversion scheme is shown in FIG. 8. The system provides a clearinghouse for credits that establishes conversion factors based on a ranking of sponsor's engagement quantified by the number of users holding a sponsor's allocated credits. In the example shown in FIG. 8, a credits database (810) may be processed by either in-database analytics or fetching the data to a separate analytics server to determine the number of users holding sponsor allocated credits for each of sponsor #1 (820), sponsor #2 (830) and sponsor #3 (840). Sponsor #1 is ranked in the highest bracket which has a conversion factor of 3 to transfer credits to the clearinghouse of the system, sponsor #2 is ranked in the medium bracket with a conversion factor of 2 to transfer credits to the clearinghouse, and sponsor #3 is ranked in the lowest bracket with a conversion factor of 1 to transfer credits to the clearinghouse. Transfer from the clearinghouse back to sponsors #1, #2 or #3 is the inverse of the respective conversion factors stated in the preceding sentence. The conversion factors may be used to determine not only the conversion between a sponsor's credits and the clearinghouse credit, but also the conversion between a first sponsor's credits and a second sponsor's credits. For example, to determine the conversion of 300 credits of sponsor #2 to sponsor #1 credits, the 300 credits is multiplied by a factor of 2 to convert to the clearinghouse value and then multiplied by a factor of 1/3 to convert from the clearinghouse value to the sponsor #1 value. Executing the two conversion calculations together results in multiplying the 300 credits of sponsor #2 by 2/3 to convert to 200 credits for sponsor #1. Conversely, a conversion of 300 credits of sponsor #1 is multiplied by 3/2 to convert to 450 of sponsor #2 credits. Many other conversion schemes may be used.

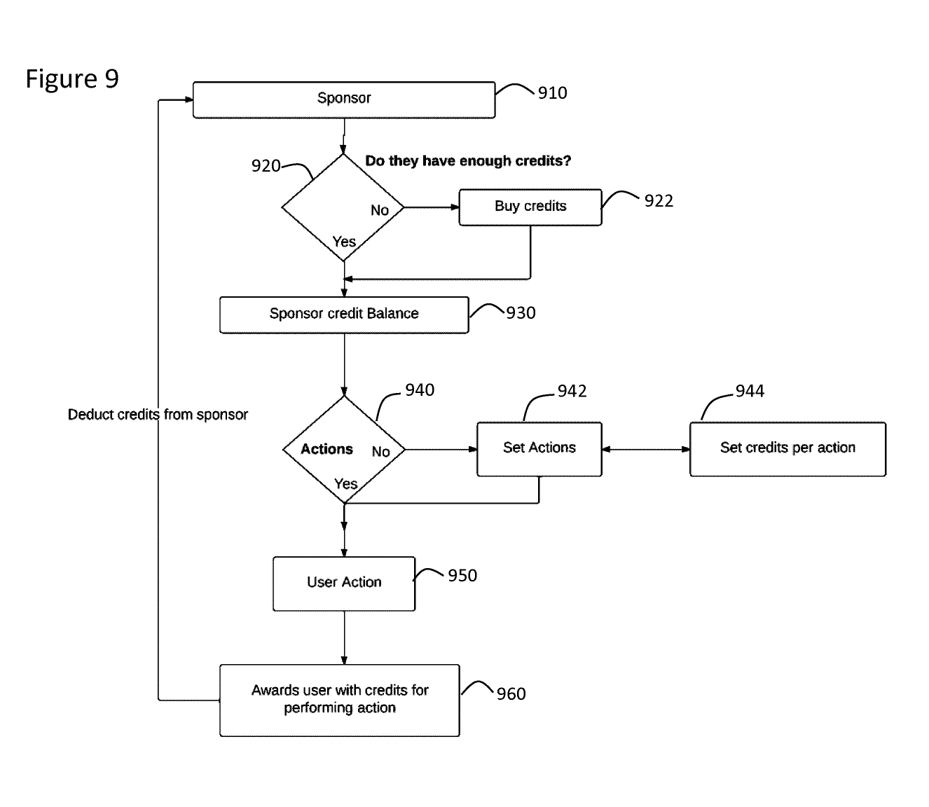

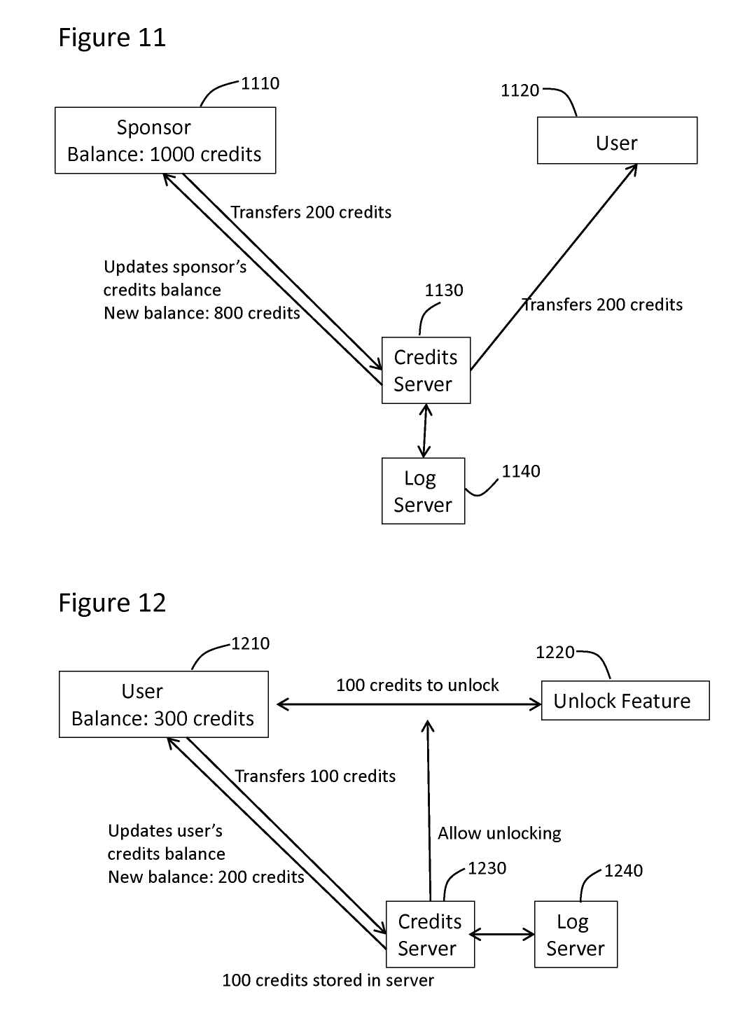

A credit tracking component for logging the transactional history of each credit or each predetermined increment or packet of credits is not critical to the system, since the system may function by recognizing a current holder of a credit without requiring information relating to previous holders. However, a credit tracking component does provide an advantage when included. For example, analysis of the transactional history of credits may increase the rate at which system prompts provided by the system are acted upon by users or may allow the system to identify brand associations between different sponsors. Credit tracking mechanisms will typically involve a log server to register each purchase, allocation, transfer, conversion and the like to document a history for each credit or each increment or packet of credits as desired. FIGS. 9 and 11 together show an example of tracking credits. In FIG. 9 a notice is sent (910) to the sponsor advising of a low credit balance. The sponsor inspects the credit balance (920) and purchases credits (922) if the credit balance is judged to be low. Otherwise, if the sponsor deems the credit balance to be sufficient (930) then credits are not purchased. The sponsor may be prompted or wish of their own accord (940) to set up an array of actions (942) with each action correlated to a credit value (944). If the actions array is established then user actions are monitored (950), and validated user actions result in the user's credit balance being increased by the credit value set in the actions array with a corresponding deduction in the sponsors credit balance. Within the context of FIG. 9, FIG. 11 shows a specific example of updating sponsor (1110) and user (1120) credit balances by a credits server (1130) as well as communication between the credits server (1130) and a log server (1140) to update the transactional history to reflect the transfer of each credit from the sponsor (1110) to the user (1120).

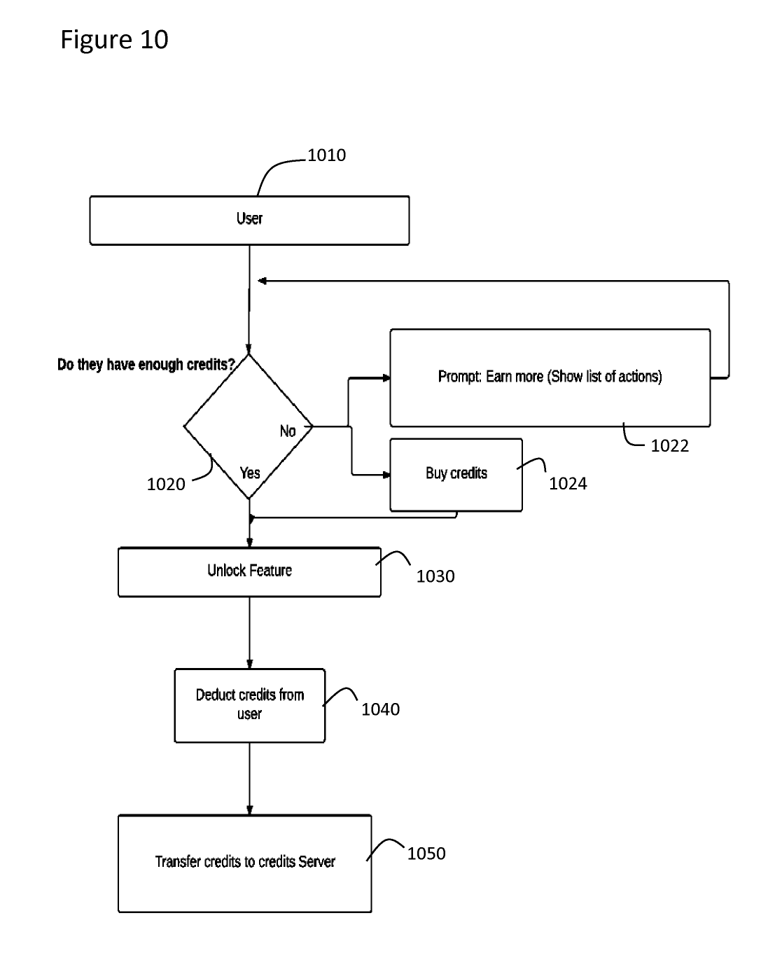

FIGS. 10 and 12 together show another example of tracking credits. In FIG. 10 a notice is sent (1010) to a user advising of a credit balance approaching a credit threshold to unlock and gain access to a desired feature. The user inspects the credit balance (1020) and either performs further promotional actions (1022) or purchases credits (1024) if the credit balance is lower than the credit threshold for the feature. Once the credit balance is equal to or greater than the credit threshold the feature is unlocked (1030) and the user's credit balance is decreased (1040) by an amount equal to the credit threshold value and corresponding amount of credits are transferred to a clearinghouse or credits server of the system (1050). Within the context of FIG. 10, FIG. 12 shows a specific example of updating a user (1210) credit balance by a credits server (1230) in order to unlock a feature (1220) desired by the user, as well as communication between the credits server (1230) and a log server (1240) to update the transactional history to reflect the transfer of each credit from the user (1210) to the credits server (1230).

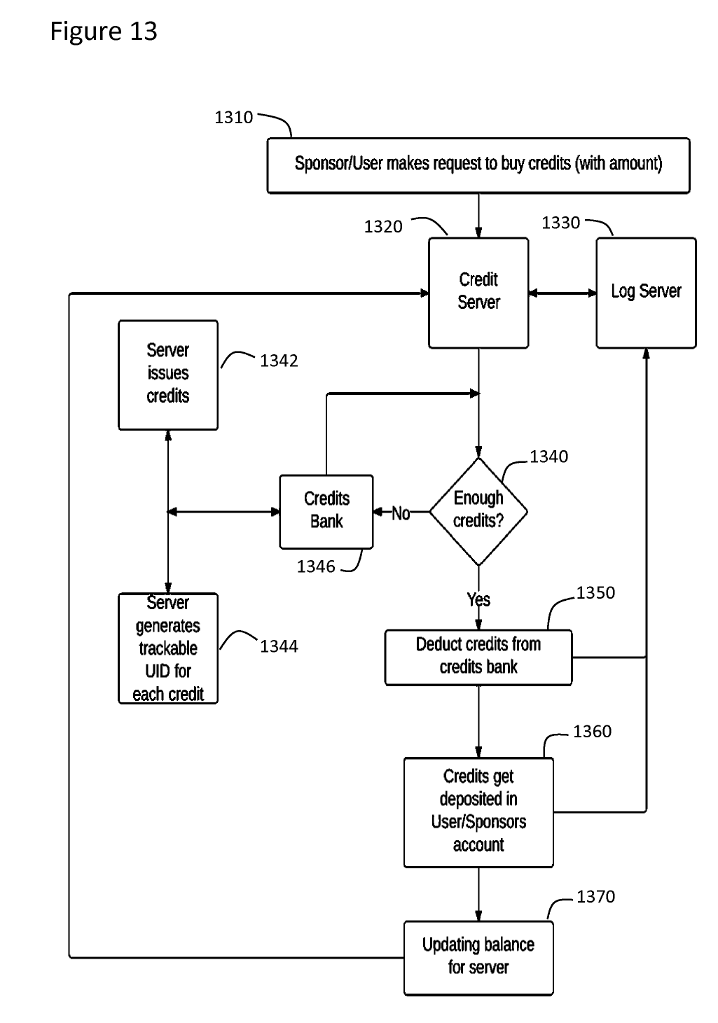

FIG. 13 shows yet another example of tracking credits. A sponsor or a user can make a request to purchase credits specifying the desired quantity of credits to be purchased (1310). The credits server receives the request (1320) and determines whether sufficient credits are available to satisfy the request (1340) based on a query of the quantity of credits in a credits bank (1346). If the credits in the credits bank is insufficient then the credits server issues credits (1342) with each credit associated with a trackable unique identifier (1344). Otherwise, if the credits bank holds a sufficient quantity of credits, then a quantity of credits equal to the quantity specified in the request (1310) is deducted from the credits bank (1350) and the credit balance of the user/sponsor account is increased (1360) and the credit balance of the credits server is decreased (1370) accordingly. In addition, the credits server (1320) sends a request to a log server (1330) to update the transactional history of each credit to reflect the transfer of each credit from the credits server (1320) to the user/sponsor.

The system may also accommodate various mechanisms for monitoring promotional actions of users. An example of an iterative analysis of user actions to identify and validate promotional actions was shown in FIG. 3. Another example is for promotional actions to be guided by wizards or assistants that validate and code the action as it is performed allowing for real time allocation of credits. Servers tasked with a monitoring function may validate each user action and/or send an approval or denial for allocation of credits.

The system may also accommodate various schemes for allocating sponsor purchased credits. The allocation of credits will typically be influenced by criteria selected and set by sponsors, such that each sponsor will be able to manage or adjust criteria to balance considerations such as cost and level of user engagement as each sponsor is provided with feedback information in their accounts, for example relating to type and amount of user activity and corresponding credit allocations. At least a portion of the criteria will provide allocation of credits based primarily on the user's actions and independent of any other user acting upon or following the user's actions.

The system can tolerate variability in structuring discount levels and the credit threshold values to achieve them. These may be guided or set by the system, may be sponsor defined, or a combination of both where the sponsor selects from predetermined options set by the system. Typically, all sponsors will provide a base discount level, for example ranging from 5% to 20%, to all users independent of the user's credit balance. Providing such a base discount level provides an immediate benefit to engage users. Further, discount levels may range between 10% to 100%. An example of discount level ranges is 5 to 20% for the first base discount level, 10% to 30% for the second discount level, 20% to 40% for the third discount level, 30% to 50% for the fourth discount level. Discount levels may be unlocked for a user by providing the user with a purchase code that may be graphically represented with the user's account as a discount coupon or badge.

Discount codes, credit holdings and other user account information may be accessed by any convenient technology including swipe, tap or chip cards and mobile application software for requesting codes and user account information. Accessing user account information by swipe, tap or chip cards and mobile application software are typically useful for user purchases and actions at a sponsor's point of sale location.

The components of the system may be administered by a single organization or a plurality of partnering organizations. The selling and/or tracking of credits, for example, may be administered by an organization at arm's length from the organization administering the rest of the system. Such an arm's length organization may be a financial institution, accounting firm or payment transaction processor.

The system may accommodate any type of end-user computing device and any type of sponsor computing device provided the computing device can be networked to the system and is configured to display website interfaces and graphical interface elements for performing the various functions of the system such as performing promotional actions or or establishing credits per action correlations for awarding performance credits. For example, the computing device may be a desktop, laptop, notebook, tablet, personal digital assistant (PDA), PDA phone or smartphone, gaming console, portable media player, and the like. The computing device may be implemented using any appropriate combination of hardware and/or software configured for wired and/or wireless communication over the network.

The server computer may be any combination of hardware and software components used to store, process and/or provide purchase, tracking and management of performance credits and monitoring and analyzing promotional actions. The server computer components such as storage systems, processors, interface devices, input/output ports, bus connections, switches, routers, gateways and the like may be geographically centralized or distributed. The server computer may be a single server computer or any combination of multiple physical and/or virtual servers including for example, a web server, an image server, an application server, a bus server, an integration server, a user profile server, a user actions server, a credits tracking server, a log server, a credits balance server, a sponsor profile server, a sponsor product server, an accounting server and the like.

Any conventional computer architecture may be used to implement the system including for example a memory, a mass storage device, a processor (CPU), a Read-Only Memory (ROM), and a Random-Access Memory (RAM) generally connected to a system bus of data-processing apparatus. Memory can be implemented as a ROM, RAM, a combination thereof, or simply a general memory unit. Software modules in the form of routines and/or subroutines for carrying out features of the sponsorship management system can be stored within memory and then retrieved and processed via processor to perform a particular task or function. Similarly, one or more of the flow diagrams shown in FIGS. 1-4 and 8-13 may be encoded as a program component, stored as executable instructions within memory and then retrieved and processed via a processor. A user input device, such as a keyboard, mouse, or another pointing device, can be connected to PCI (Peripheral Component Interconnect) bus. The software will typically provide an environment that represents programs, files, options, and so forth by means of graphically displayed icons, menus, and dialog boxes on a computer monitor screen.

A data-process apparatus can include CPU, ROM, and RAM, which are also coupled to a PCI (Peripheral Component Interconnect) local bus of data-processing apparatus through PCI Host Bridge. The PCI Host Bridge can provide a low latency path through which processor may directly access PCI devices mapped anywhere within bus memory and/or input/output (I/O) address spaces. PCI Host Bridge can also provide a high bandwidth path for allowing PCI devices to directly access RAM.

A communications adapter, a small computer system interface (SCSI), and an expansion bus-bridge may also be attached to PCI local bus. The communications adapter can be utilized for connecting data-processing apparatus to a network. SCSI can be utilized to control a high-speed SCSI disk drive. An expansion bus-bridge, such as a PCI-to-ISA bus bridge, may be utilized for coupling ISA bus to PCI local bus. PCI local bus can be connected to a monitor, which functions as a display (e.g., a video monitor) for displaying data and information for an operator and also for interactively displaying a graphical user interface.

A database can contain information on a variety of matters such as data relating to credit allocation, tracking, and conversion. For example, a database may contain user profiles, user actions, sponsor profiles, product profiles, credit transaction history and/or credit conversion information. A user profile may include, but is not limited to, a user identifier such as login name, a password, contact information, mailing information, billing information, saved product searches, and/or user preferences for use in searching database and/or displaying product searches. A sponsor profile may include, for example, sponsor identifier such as a login name, a password, contact information, mailing and/or shipping information, billing and/or invoicing information, and/or offer information. For example, offer information may include an offer to be promoted from a first discount level to a second discount level correlated to a credit threshold value.

A database can also maintain information to incorporate an e-commerce platform for participating sponsors. Typically, the database can include sponsor product, such as a good or a service, information including, for example, a UPC code, a product description, credits for purchasing a product, a current item quantity, a product image gallery, warranty cost, a minimum cost, a product weight which is used as part of the shipping costs, an extended product description, and the like.

The system may be implemented by incorporating existing technologies. Table 1 provides an example of a contemplated technology stack as well as suitable alternatives.

TABLE 1
Illustrative technology stack for implementing the system.

| | Technology | Alternative Technology |
|---|---|---|
| Server | NGINX, PASSANGER | APACHE |
| Database | MONGODB | MYSQL, POSTGRESQL, MS |
| | | SQL, ORACLE, ACCESS, |
| | | CASSANDRA, COUCHDB, |
| | | HBASE (HADOOP), ETC |
| Back-end | RUBY ON RAILS | PYTHON/DJANGO, PHP, |
| | | ASPX, SCALA, JAVA, C/C++ |
| Front-end | HTML5, CSS3, | HTML, CSS3, FLASH |
| | JAVASCRIPT, JQUERY, | |
| | COFFEESCRIPT, | |
| | JSON, XML | |

The network may be a single network or a combination of multiple networks. For example, the network may include the internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. Typically, the network will comprise a computer network that makes use of a TCP/IP protocol (including protocols based on TCP/IP protocol, such as HTTP, HTTPS or FTP).

The system may be adapted to follow any computer communication standard including Extensible Markup Language (XML), Hypertext Transfer Protocol (HTTP), Java Message Service (JMS), Simple Object Access Protocol (SOAP), Representational State Transfer (REST), Lightweight Directory Access Protocol (LDAP), Simple Mail Transfer Protocol (SMTP) and the like.

The system may accommodate any type of still or moving image file including JPEG, PNG, GIF, PDF, RAW, BMP, TIFF, MP3, WAV, WMV, MOV, MPEG, AVI, FLV, WebM, 3GPP, SVI and the like. Furthermore, the system may accommodate any conventional methods of image analysis to identify the promotional merit of a posted image.

The system may guide or prompt user attempts at performing promotional actions by any convenient form of user interface element including, for example, a window, a tab, a text box, a button, a hyperlink, a drop down list, a list box, a check box, a radio button box, a cycle button, a datagrid or any combination thereof. Furthermore, the user interface elements may provide a graphic label such as any type of symbol or icon, a text label or any combination thereof. The user interface elements may be spatially anchored or centered around a portion of the user's social networking page dedicated to providing information relating to the user's credit balance and credit transactional history. It will be recognized however, that any desired spatial pattern or timing pattern of appearance of user interface elements may be accommodated by the system. Any number of promotional actions may be associated with performance credits, and each action may be represented by one or more user interface elements as desired.

The system described herein and each variant, modification or combination thereof may also be implemented as a method or code on a computer readable medium (i.e. a substrate). The computer readable medium is a tangible data storage device that can store data, which can thereafter, be read by a computer system. Examples of a computer readable medium include read-only memory, random-access memory, CD-ROMs, magnetic tape, optical data storage devices and the like. The computer readable medium may be geographically localized or may be distributed over a network coupled computer system so that the computer readable code is stored and executed in a distributed fashion.

Still further variants, modifications or combinations thereof will be recognized by the person of skill in the art.

1-141. (canceled)

142. A system for promoting a user of a social network from a first discount level to a second discount level for purchasing a sponsor's product, comprising:
a storage system for storing a plurality of user records and a plurality of sponsor records, each user record comprising a user identifier and a quantity of allocated credits to the user and each sponsor record comprising a sponsor identifier, a quantity of sponsor-purchased credits, criteria for allocating credits and a credit threshold for promotion from the first discount level to the second discount level; and
a processor configured to update the quantity of sponsor-purchased credits in each sponsor record in response to receiving a credit purchase request from a sponsor identified in the sponsor record; to allocate sponsor-purchased credits to add to the quantity of allocated credits in each user record based on corresponding user actions in a social network; and to receive information relating to the quantity of allocated credits from each user record and promote the user from a first discount level to a second discount level for purchasing a sponsor's products by comparing the information relating to the quantity of allocated credits to the credit threshold for the promotion, the second discount level providing a greater discount than the first discount level.

143. The system of claim 142, wherein the first discount level is a base discount level that is available to the plurality of user's to purchase the sponsor's product independent of credits accumulated by each user.

144. The system of claim 142, wherein the criteria for allocating credits is an array comprising a plurality of user action types, each user action type correlated with a credit value.

145. The system of claim 144, wherein the user action type is selected from the group consisting of a purchase, a scan of a product code, a geographical check-in, an image of a product posted in the social network, a text testimonial posted in the social network, a video testimonial posted in the social network, and a video showing use of the product posted in the social network.

146. The system of claim 142, wherein at least 50% of the total credits in the system originated as sponsor-purchased credits.

147. The system of claim 142, wherein the sponsor can set criteria for allocating credits in a plurality of social networks, and the criteria are different for each of the plurality of social networks.

148. The system of claim 142, further comprising a converter to convert a first sponsor's credits to a second sponsor's credits.

149. A method for promoting a user of a social network from a first discount level to a second discount level for purchasing a sponsor's product, comprising:
storing user records in a storage system, each user record comprising a user identifier and a quantity of allocated credits to the user;
storing sponsor records in the storage system, each sponsor record comprising a sponsor identifier, a quantity of sponsor-purchased credits, criteria for allocating credits and a credit threshold for promotion from the first discount level to the second discount level;
updating the quantity of sponsor-purchased credits in each sponsor record in response to receiving a credit purchase request from a sponsor identified in the sponsor record;
allocating sponsor-purchased credits to add to the quantity of allocated credits in each user record based on corresponding user actions in a social network;
receiving information relating to the quantity of credits allocated in a user record; and
promoting the user from a first discount level to a second discount level for purchasing a sponsor's products by comparing the information relating to the quantity of allocated credits to the credit threshold for the promotion, the second discount level providing a greater discount than the first discount level.

150. The method of claim 149, wherein the first discount level is a base discount level that is available to the users to purchase the sponsor's product independent of credits allocated in the user records.

151. The method of claim 149, wherein the criteria for allocating credits is an array comprising a plurality of user action types, each user action type correlated with a credit value.

152. The method of claim 151, wherein the user action type is selected from the group consisting of a purchase, a scan of a product code, a geographical check-in, an image of a product posted in the social network, a text testimonial posted in the social network, a video testimonial posted in the social network, and a video showing use of the product posted in the social network.

153. The method of claim 149, wherein at least 50% of the total credits stored within the sum of all user records and all sponsor records originated as sponsor-purchased credits

154. The method of claim 149, further comprising receiving sponsor selected criteria for allocating credits in a plurality of social networks, and the criteria are different for each of the plurality of social networks.

155. The method of claim 149, further comprising converting a first sponsor's credits to a second sponsor's credits within a user record to make up a difference between the second sponsor's credits stored in the user record and a credit threshold set by the second sponsor.

156. A computer readable medium embodying a computer program for promoting a user of a social network from a first discount level to a second discount level for purchasing a sponsor's product, comprising:
computer program code for storing user records in a storage system, each user record comprising a user identifier and a quantity of allocated credits to the user;
computer program code for storing sponsor records in the storage system, each sponsor record comprising a sponsor identifier, a quantity of sponsor-purchased credits, criteria for allocating credits and a credit threshold for promotion from the first discount level to the second discount level;
computer program code for updating the quantity of sponsor-purchased credits in each sponsor record in response to receiving a credit purchase request from a sponsor identified in the sponsor record;
computer program code for allocating sponsor-purchased credits to add to the quantity of allocated credits in each user record based on corresponding user actions in a social network;
computer program code for receiving information relating to the quantity of allocated credits in a user record; and
computer program code for promoting the user from a first discount level to a second discount level for purchasing a sponsor's products by comparing the information relating to the quantity of allocated credits to the credit threshold for the promotion, the second discount level providing a greater discount than the first discount level.

157. The computer readable medium of claim 156, wherein the first discount level is a base discount level that is available to the users to purchase the sponsor's product independent of credits allocated in the user records.

158. The computer readable medium of claim 156, wherein the criteria for allocating credits is an array comprising a plurality of user action types, each user action type correlated with a credit value.

159. The computer readable medium of claim 158, wherein the user action type is selected from the group consisting of a purchase, a scan of a product code, a geographical check-in, an image of a product posted in the social network, a text testimonial posted in the social network, a video testimonial posted in the social network, and a video showing use of the product posted in the social network.

160. The computer readable medium of claim 156, wherein at least 50% of the total credits stored within the sum of all user records and all sponsor records originated as sponsor-purchased credits.

161. The computer readable medium of claim 156, further comprising computer program code for receiving sponsor selected criteria for allocating credits in a plurality of social networks, wherein the criteria are different for each of the plurality of social networks.

162. The computer readable medium of claim 156, further comprising computer program code for converting a first sponsor's credits to a second sponsor's credits within a user record to make up a difference between the second sponsor's credits stored in the user record and a credit threshold set by the second sponsor.
